(19) United States
(12) Patent Application Publication
(10) Pub. No.: US 2025/0165607 A1
(43) Pub. Date: May 22, 2025

(54) ON-THE-FLY AND SECURE FIRMWARE UPDATES FOR CIRCUIT INTERRUPTERS

(71) Applicant: ABB Schweiz AG, Baden (CH)

(72) Inventors: Felix Sutton, Baden (CH); Philipp Scholl, Baden (CH); Philipp Sommer, Baden (CH)

(21) Appl. No.: 18/515,875

(22) Filed: Nov. 21, 2023

(51) Int. Cl. G06F 21/57; G06F 21/60; G06F 21/64

(52) U.S. Cl. CPC G06F 21/572; G06F 21/606; G06F 21/64

(57) ABSTRACT

Devices and methods for on-the-fly updates of circuit breakers during operation, the circuit breaker including a processor, a first memory including a first and second slot, and a second memory. In response to initialization, the processor stores a copy of a most recent firmware from the first or second slot in the second memory and executes the most recent firmware at the second memory. The firmware in the first or second slot may be a first firmware, and in response to obtaining a second firmware, the processor stores a copy of the second firmware in the other of the first and second slot. In response to a second initialization, the processor stores a copy of the second firmware from the other of the first slot and second slot in the second memory to enable execution of the second firmware, the second firmware being the most recent firmware.

### FIELD

The present disclosure relates to the field of circuit interrupters. More particularly, to systems and methods for updating firmware on circuit interrupters.

### BACKGROUND

Electrical fires pose a threat to life, property, and the environment. Circuit interrupters are meant to protect against such electrical fires. For example, defects in an electrical power line can lead to electrical arcs (e.g., ground short) that can cause damage to electrical devices (e.g., loads) connected to the power line. Electrical faults on the power line are detected by monitoring with a controller (e.g., micro-controller). The electrical current on the power line is transformed into a digital signal and a decision algorithm is utilized to monitor for patterns in the digital signal which indicate an electrical fault. Upon detection of a fault pattern, the controller causes the circuit interrupter to trip to electrically isolate the downstream electrical devices (e.g., loads) from the power source.

### SUMMARY

Circuit interrupters, which may also be referred to as circuit breakers or smart circuit breakers, are electrical safety devices that include a controller that, when powered, continuously monitors the electrical current in a power line (e.g., monitors a digital signal generated based on the electrical current) for detection of patterns indicative of an electrical fault. When a fault pattern is detected by the controller, the controller triggers the circuit interrupter to trip open, thereby isolating the electrical devices downstream of the circuit interrupter from the electrical power source. However, electrical device(s) in electrical connection with the power line can also affect the electrical current patterns monitored by the controller, causing patterns in the transformed digital signal which the controller interprets as indicative of an electrical fault when in reality the electrical current is within normal operating parameters. For example, normal operation of household appliances connected to the electrical power line and monitored by the controller can be interpreted as pattern(s) indicative of an electric fault and the controller can erroneously trip open the circuit interrupter. In another example, new electrical devices, either individually or when added in combination with one or more other electrical devices to the power line, can lead to patterns which the controller identifies as corresponding to a fault condition and causes the circuit interrupter to trip open.

The firmware can include instructions that when executed by the controller (e.g., the processor) enables the controller to perform the operations in accordance with the present disclosure and known to those having ordinary skill in the art. Reprogramming the firmware, e.g., arc fault detection algorithm that provides the safety functionalities of the circuit breaker, with updated firmware can be beneficial since there can be a large number of different load combinations in electrical connection with the circuit breaker and testing for all possible combinations is not practical. Furthermore, new electrical devices can be connected with the power line that can cause previously unseen patterns which may be identified as indicative of electrical faults. In this regard, reprogramming the controller's firmware makes it possible to update the decision algorithm and exclude such nuisance tripping.

Controllers for electronic circuit breakers are typically initially programmed at the manufacturer level to carry out its safety functionalities such as detecting electrical faults on the electrical power line and issuing trip commands. After installation of the circuit interrupter into an electrical system, novel load signatures erroneously identified as fault patterns may cause nuisance tripping. The conventional approach for remedying such nuisance tripping can typically include replacing the controller and/or circuit interrupter with a new circuit breaker device having stored thereon updated firmware that corrects for such nuisance tripping instances, or by remotely uploading a firmware update to the controller that corrects for the previous causes of the nuisance tripping.

To avoid replacement of an operable circuit interrupter for application (e.g., firmware) update purposes, circuit interrupters may be upgradable through different communication interfaces. These can be either wired, e.g., a serial line or power line, or wirelessly through communication interfaces, e.g., Wi-Fi or Bluetooth. A method of reprogramming of the breaker with an external programmer where physical access to the breaker is not needed is described in U.S. Pat. No. 7,558,038 B2, the entire disclosure of which is hereby incorporated by reference.

Per common industry standards, updates to circuit interrupters (e.g., firmware updates) cannot compromise the safety or functionality being provided by the circuit interrupter device, that is, the safety operation, i.e., the execution of the firmware cannot be suspended. Either the circuit interrupter needs to be open to disconnect the source from the load while still powering the circuit interrupter, or a dual-mode flash memory may be utilized. Conventional circuit interrupters and corresponding controllers typically include dual mode flash memory that may utilize dedicated update modes for updating the firmware stored thereon in the memory of the controller. To update the firmware, conventional circuit interrupters switch to an open state, thereby disconnecting any downstream electrical load devices on the power line from the upstream electrical power source and powering the controller and one or more of its components for purposes of updating the firmware. The circuit interrupter is thereby transitioned from a normal operating state and into a safe state (e.g., safe mode) for a period of time while performing the firmware update.

In conventional circuit interrupters, the controller operates in a safe state during firmware update and reboot, where the circuit interrupter is open and unpowered. Once completed, the controller switches back to the normal operating state, where the circuit interrupter is closed and powered.

The one or more embodiments of the instant application maintain the circuit breaker device in the normal operating state by the associated controller and continues delivering electrical power to downstream electrical loads from the upstream electrical power sources through the circuit breaker device during the storing of the firmware onto a non-volatile memory of the circuit breaker device or controller. Being able to dynamically upload a firmware update to the controller on-the-fly and while in operation (i.e., in a normal operating mode) saves time and effort from a user having to disconnect the electrical load devices from the currently connected electrical power source. For example, the length of time the electrical load devices are disconnected from the electrical power source due to conventional circuit breakers being placed into the safe state and the length of time the controller remains in that safe state is dependent on the time it takes to download and install the new firmware, which can be prolonged due to the controller waiting until the circuit breaker device is in the safe state prior to commencing with receiving and storing the firmware update to be used when the circuit interrupter is powered on again (e.g., transitioned back to the normal operating mode).

Various embodiments of the present disclosure relate to systems, devices, and methods for field-upgradable circuit interrupters and controllers that may obtain and store on-the-fly updates to a memory of the circuit interrupter. The circuit breaker may include a processor, a non-volatile memory, and a volatile memory. A firmware may be stored onto an available slot of the non-volatile memory (e.g., firmware installed at manufacture). During initialization, the circuit interrupter copies the most recent firmware from the respective slot in the non-volatile memory and stores the copy of the firmware onto the volatile memory. In some embodiments, the circuit breaker may also validate the firmware copy being stored onto the volatile memory prior to execution of the firmware stored in the volatile memory.

In various embodiments, the circuit interrupter may also obtain new firmware updates, which provides new or improved functionalities including improved safety functionalities for reducing the frequency of nuisance tripping. The newly obtained firmware updates may be stored onto the non-volatile memory. Upon initialization of the circuit interrupter after the new firmware update is stored onto the non-volatile memory, the updated firmware may be copied and stored onto the volatile memory for execution, that is, the controller identifies the most recent firmware stored in one of the plurality of slots of the non-volatile memory, copies the most recent firmware, and stores the most recent firmware onto the volatile memory for execution.

In various embodiments, the circuit interrupter may include a single mode non-volatile memory (e.g., flash memory) that enables firmware updates to be obtained and written onto the non-volatile memory while the circuit interrupter and controller are in a normal operating condition, rather than in a safe mode, and concurrently performing the safety functionalities such as, for example, providing arc fault protection to connected downstream electrical load devices. In this regard, newly obtained firmware updates may be written onto the memory of the circuit interrupter device and/or controller while in a normal operating condition with the circuit interrupter being in a closed state and connecting downstream electrical devices with an electrical power source on the power line. The various embodiments described herein thereby maintain the safety functionalities of the circuit interrupter and enable continued operation to provide on-the-fly update capabilities without needing to disconnect the protected electrical circuit or be placed into a safe mode.

Various embodiments of the present disclosure include techniques and/or methods for obtaining a firmware update and storing the new firmware instructions in an available slot in a non-volatile memory while the controller continues normal operation using the previous version instructions stored and executed by the controller in a volatile memory. When the electrical circuit is in a condition where the firmware may be updated, the circuit interrupter device (e.g., controller) may be reset, that is, the power may be cycled off and on, to initialize the controller and to enable the most recent firmware from one of the slots in non-volatile memory (e.g., where the new firmware update was stored) to be buffered and written (e.g., stored) onto the volatile memory for execution by the controller (e.g., processor) during this cycle. In some embodiments, the non-volatile memory may include two slots. In other embodiments, the non-volatile memory may further include a third slot. In yet other embodiments, the non-volatile memory may further include a plurality of other slots for storing firmware or other data of the circuit interrupter (e.g., pattern data).

In various embodiments, the controller may also perform operations including validating the firmware prior to executing the firmware from the volatile memory, that is, the security and integrity of the program may be validated prior to executing the most recent firmware stored in volatile memory. The controller may validate the firmware for authenticity (i.e., originates from a known source) and integrity (i.e., not modified by an adversary or corrupted). If either of those checks fail, the controller will instead obtain the next most recent firmware (e.g., previous iteration firmware successfully executed on the circuit interrupter prior to the failed firmware) from its respective slot in the non-volatile memory and copy and store the firmware to the volatile memory for execution instead of the failed firmware in order to provide a fail-safe mechanism against corruption of the instructions or tampering. In this regard, the controller may validate the security of the firmware that is being copied and stored in the volatile memory and prior to executing the firmware.

In various embodiments, the circuit interrupter device described herein can include capabilities including wired and/or wireless communication to enable updating the firmware without removing the circuit interrupter from the electrical circuit. The circuit interrupter may be connected to other devices or networks via various wireless protocols, such as Bluetooth, Zigbee, and the like. As a result, data (e.g., firmware, software, monitoring data, operational parameters, etc.) can be transferred between a load center and the circuit interrupter device. In some embodiments, data may be transferred from the load center to a computing device associated with a user of the circuit interrupter via a network, and the circuit interrupter may be placed in electrically communicable connection (e.g., via Bluetooth) with the computer device of the user to obtain the data.

In some embodiments, a system includes a circuit breaker including a processor, and a first memory including a plurality of slots including a first slot, and a second slot; and a second memory. In some embodiments, in response to an initialization of the processor, the processor stores a copy of a most recent firmware obtained by the circuit breaker from one of the first slot and the second slot of the first memory in the second memory.

In some embodiments, in response to a first initialization, the processor stores a copy of a first firmware from the first slot or the second slot of the first memory in the second memory and executes the first firmware in the second memory.

In some embodiments, in response to obtaining a second firmware, the processor stores the second firmware in the other of the first slot and the second slot not storing the first firmware, in response to a second initialization of the processor after obtaining the second firmware, the processor stores a copy of the second firmware from the other of the first slot and the second slot in the first memory in the second memory to enable execution of the second firmware. In some embodiments, the first firmware is a previous firmware stored in the first memory, and the second firmware is the most recent firmware stored in the first memory.

In some embodiments, the processor stores the second firmware in an available slot of the first slot and the second slot of the first memory such that execution of the first firmware is uninterrupted.

In some embodiments, the circuit breaker further includes a wireless communication module, the wireless communication module is configured to be placed in electronically communicable connection with an external computing device to send and receive data including firmware.

In some embodiments, the first memory includes a non-volatile computer readable media; the second memory includes a volatile computer readable media.

In some embodiments, the first memory includes a flash memory; the second memory includes a RAM.

In some embodiments, the processor is further configured to perform a validation of the most recent firmware before executing the most recent firmware stored in the second memory.

In some embodiments, in response to failing the validation of the most recent firmware, storing a copy of a previous firmware relative the most recent firmware in the second memory, and performing the validation of the previous firmware before executing the previous firmware.

In some embodiments, a circuit breaker device includes a processor, a non-volatile computer readable media including at least two slots, a first firmware is stored in a first slot or a second slot, a volatile computer readable media, and the processor is configured to perform operations including in response to a first initialization, the processor stores a copy of the first firmware from the first slot or the second slot and in the volatile computer readable media and executes the first firmware in the volatile computer readable media, in response to obtaining a second firmware, the processor stores the second firmware in the other of the first slot and the second slot not storing the first firmware, and in response to a second initialization of the processor after obtaining the second firmware, the processor stores a copy of the second firmware from the other of the first slot and the second slot of the non-volatile computer readable media in the volatile computer readable media to enable execution of the second firmware. In some embodiments, the first firmware is a previous firmware stored in the non-volatile computer readable media, and the second firmware is a most recent firmware stored in the non-volatile computer readable media. In some embodiments, the processor stores the second firmware in an available slot of the first slot and the second slot of the non-volatile computer readable media such that execution of the first firmware is uninterrupted.

In some embodiments, the device further includes a wireless communication module, the wireless communication module is configured to be placed in electronically communicable connection with an external computing device to send and receive data including at least one of the first firmware and second firmware.

In some embodiments, the non-volatile computer readable media includes a flash memory.

In some embodiments, the volatile computer readable media includes a RAM.

In some embodiments, the processor is further configured to perform operations including performing a validation of the most recent firmware before executing the most recent firmware stored in the volatile computer readable media.

In some embodiments, the processor is further configured to perform operations including in response to failing the validation of the most recent firmware, storing a copy of a previous firmware relative the most recent firmware in the volatile computer readable media, and performing the validation of the previous firmware before executing the previous firmware.

In some embodiments, a method includes copying, by a processor in response to an initialization, a most recent firmware from a slot of a plurality of slots at a first memory, storing, by the processor, the most recent firmware in a second memory, and executing, by the processor, the most recent firmware stored in the second memory to enable the processor to provide safety functionalities for a circuit breaker based on the most recent firmware. In some embodiments, the most recent firmware is a first firmware.

In some embodiments, the method further includes obtaining, by the processor, a second firmware, and storing, by the processor, the second firmware in an available second slot of the plurality of slots at the first memory, the processor storing the second firmware in the first memory does not interrupt execution of the first firmware.

In some embodiments, the first firmware is a previous firmware, and the second firmware is the most recent firmware. In some embodiments, the initialization of the processor causes the processor to copy and store the most recent firmware from the first memory in the second memory for execution.

In some embodiments, the method further includes performing a validation of the most recent firmware stored in the second memory, and executing, by the processor in response to passing the validation, the most recent firmware in the second memory.

In some embodiments, a method, the first memory further includes a previous firmware stored at an available second slot of the plurality of slots, and the method further includes copying, by the processor, the previous firmware in the first memory, storing, by the processor, the previous firmware in the second memory, performing a validation of the previous firmware, and executing, by the processor in response to passing the validation, the previous firmware stored in the second memory to enable the processor to perform the safety functionalities based on the previous firmware.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 shows a non-limiting example system for enabling a circuit breaker to obtain firmware, according to some embodiments.

FIG. 2 shows a block diagram illustrating a non-limiting example of circuit breaker of the system of FIG. 1, according to some embodiments.

FIG. 3a shows a block diagram illustrating a portion of the circuit breaker of FIG. 1, according to some embodiments.

FIG. 3b shows a block diagram illustrating a portion of the circuit breaker of FIG. 1, according to some embodiments.

FIG. 4 is a flow diagram illustrating a method, according to some embodiments.

FIG. 5 is a flow diagram illustrating a portion of the method, according to some embodiments.

FIG. 6 is a flow diagram illustrating a portion of the method, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

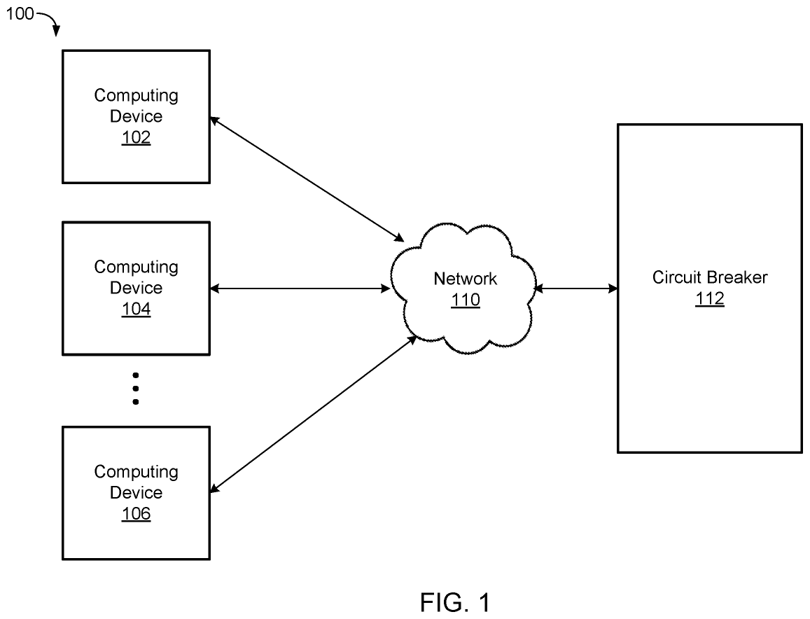

FIG. 1 shows a non-limiting example system 100 for enabling a circuit breaker to obtain firmware, according to some embodiments. It is to be appreciated by those having ordinary skill in the art that it may be possible for the circuit breaker to send and receive data other than firmware updates using the systems and methods described in the present disclosure. In the illustrated example embodiment, the system 100 includes computing device 102, computing device 104, and through computing device 106, and a circuit breaker 112. It is to be appreciated by those having ordinary skill in the art that the number of computing device 102, 104, 106 can vary beyond the illustrated number of three shown in FIG. 1. That is, in some embodiments, there can be fewer than three computing device 102, 104, 106. In other embodiments, there can be more than three computing device 102, 104, 106.

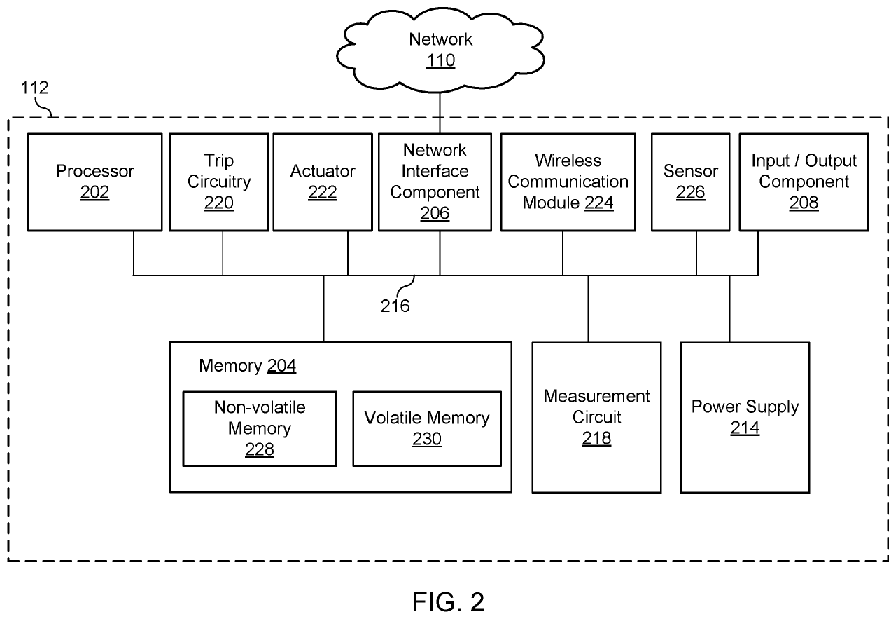

The computing devices 102, 104, 106 may be one or more computing devices that can include a mobile computer, desktop computer, mobile phone, tablet, personal digital assistant (“PDA”), or other computing device capable of sending and/or receiving data with the circuit breaker 112. In some embodiments, the computing devices 102, 104, 106 may also be capable of sending and/or receiving data from one or more other computing devices. For example, computing device 102 may obtain the firmware update from computing device 104 and the circuit breaker 112 may obtain the firmware update from computing device 102. In some embodiments, the computing devices 102, 104, 106 can include, but are not limited to, a desktop computer, a mobile cellular phone, a tablet device, a wearable device such as a smartwatch or the like, or other like devices. In some embodiments, the circuit breaker 112 and the computing devices 102, 104, and 106 may be connected in electronic communication via a wireless interface (e.g., wireless communication module 508 as shown in FIG. 2). In some embodiments, the computing devices 102, 104, 106 may be in electronically communicable connection with the circuit breaker 112 via a network 110.

In some embodiments, the circuit breaker 112 can include one or more components located therein for being placed in electronically communicable connection with at least one of the computing devices 102, 104, 106 to obtain data from the respective computing devices 102, 104, 106. For example, a processor (e.g., processor 202 in FIG. 2) may perform operations including obtaining the firmware from computing device 102 and storing the firmware in a memory (e.g., memory 204 in FIG. 2). In some embodiments, the computing devices 102, 104, 106 can be a computing device associated with a technician such as, but not limited to, an electrician or the like. In other embodiments, the computing device 102, 104, 106 may be associated with an owner of the downstream electrical devices. For example, in some embodiments, a building owner can be the user associated with at least one of computing devices 102, 104, 106.

The computing devices 102, 104, and 106 may be connected in electronic communication with the circuit breaker 112 through network 110 to transfer data, such as the firmware, between the computing device 102, 104, and 106 and the circuit breaker 112. The circuit breaker 112 can also send and receive data to other computing devices, such as, but not limited to, a server device or the like and which can correspond to any electronic data acquisition processes (e.g., from third parties through an application programming interface-API). In some embodiments, the network 110 can be the Internet. In other embodiments, the network 110 can be a cellular network. In some embodiments, the network 110 can be configured for wireless communication protocols including, but not limited to, Bluetooth, Zigbee, WiFi, LTE, 4G, 5G, CDMA, other wireless communication protocols, or any combinations thereof.

The circuit breaker 112 can be managed by, or otherwise associated with, an enterprise (e.g., a utility company) that may use the system 100 for programming and managing circuit breakers such as, for example, circuit breaker 112, and for managing one or more operations associated with the circuit breaker 112 including updating firmware. In some embodiments, the circuit breaker 112 can receive data from one or more of the computing device 102, 104, and 106.

In some embodiments, the circuit breaker 112 can be a low-voltage circuit breaker. In some embodiments, the circuit breaker 112 can be a residential circuit breaker. In some embodiments, the circuit breaker 112 can be utilized in a non-residential setting such as, but not limited to, a commercial or industrial building or the like.

FIG. 2 shows a block diagram illustrating a non-limiting example of circuit breaker 112 of the system 100 of FIG. 1, according to some embodiments.

In various embodiments, the circuit breaker 112 includes therein one or more components for controlling operations of the circuit breaker 112 as described herein or any other functions typically associated with other like circuit breakers. In some embodiments, the circuit breaker 112 may include therein a controller (not shown) including one or more of the components described herein for providing the circuit breaker 112 with safety functionalities. In some embodiments, the circuit breaker 112 may include instructions corresponding to one or more algorithms for detecting electrical faults in an electrical power line being monitored by the circuit breaker 112, as will be further described herein. These types of electrical faults may be caused by, for example, loose connections or faulty wiring that causes sparking or arcing, resulting in dangerous conditions that can cause electrical fires.

In some embodiments, the circuit breaker 112 includes processor 202, memory 204, network interface component 206, input/output component 208, power supply 214, system bus 216, measurement circuit 218, trip circuitry 220, actuator 222, wireless communication module 224, and sensor 226. It is to be appreciated by those having ordinary skill in the art that the architecture of circuit breaker 112 as shown in FIG. 2 is exemplary and that the circuit breaker 112 can include one or more of the components as described herein to enable performing the operations in accordance with the present disclosure.

In some embodiments, firmware that is transferred from the computing devices 102, 104, or 106 can be received by the processor 202 that is executing the protection algorithms, such as an arc fault or ground fault protection. In some embodiments, the processor 202 can include a single processor, multiple processors, a processor with multiple cores, other configurations, or any combinations thereof. Once the data is obtained and stored in the memory 204, the circuit breaker 112 may be reset, allowing the new firmware to be utilized by the circuit breaker 112, as discussed below.

The circuit breaker 112 may be reset to initialize the circuit breaker 112 and/or the controller including the one or more components therein. The reset may be performed remotely, in some embodiments. For example, the reset may be performed at computing device 102, computing device 104, computing devices 106, or another computing device. The reset may be performed from a dedicated local button on the circuit breaker 112, such as located on a housing of the circuit breaker 112.

At circuit breaker 112, the reset may initialize (or reinitialize) the controller without interrupting power between the one or more electrical devices and the electrical power source, according to some embodiments. That is, monitoring by the controller may be unavailable while the initialization (or reinitialization) is being performed but power would continue to be provided from the electrical power source on the electrical circuit to the connected electrical load devices through circuit breaker 112. In some embodiments, the circuit breaker 112 may be reset without interrupting power at the electrical circuit as long as a time period of the monitoring outage is less than a maximum allowable outage, which may be a time period determined by the manufacturer, a user, or by regulation. In this regard, the controller may be capable of obtaining a firmware update, storing the firmware update onto non-volatile memory 228, and may then initialize the controller without interrupting power on the electrical circuit between the power source and the electrical load devices. Initializing the controller may include copying the most recent firmware (e.g., firmware update) stored onto non-volatile memory 228 and writing that firmware onto volatile memory 230 to enable the processor 202 to execute that most recent firmware stored onto volatile memory 230 for controlling operations of the circuit breaker 112.

Once the processor 202 obtains the firmware, the processor 202 stores the data in the memory 204. The memory 204 may be a computer readable data storage media including volatile and non-volatile memory having stored thereon instructions (e.g., firmware, software, other data) and which may be executable by the processor 202 for performing one or more operations as described herein. The memory 204 may be implemented in any method or technology for storage of information such as computer-readable software instructions, data structures, program modules, or other data. Example types of computer-readable data storage media include, but are not limited to, RAM, ROM, EPROM, EEPROM, flash memory, other solid-state memory technology, CD-ROMs, digital versatile discs (“DVDs”), other optical storage media, magnetic cassettes, magnetic tape, magnetic disk storage, other magnetic storage devices, other data storage medium, or any combinations thereof which can be used for reading/writing and which can be accessed by the processor 202 and/or any of the one or more other components of circuit breaker 112.

In various embodiments, the memory 204 may include a non-volatile memory 228 and a volatile memory 230. When the processor 202 first obtains a new firmware update from an external computing device (e.g., computing devices 102, 104, 106), the processor 202 may be configured to write (e.g., store) the new firmware in the non-volatile memory 228, in some embodiments. In addition, when the circuit breaker 112 is reset or cycled on and off, the processor 202 may also be configured to obtain the updated firmware from its slot location in the non-volatile memory 228 and copy, buffer, and write it onto the volatile memory 230 for execution. In some embodiments, the processor 202 may be configured to execute the firmware version from the volatile memory 230.

Non-volatile memory 228 operates as programmable memory including therein one or more slot locations partitioning the available memory, and where firmware is stored and retained (in one of the available slot locations) after a reset or power cycle. In some embodiments, power cycling can occur by physically opening and closing the handle on the circuit breaker 112. For example, the handle of the circuit breaker 112 can be toggled to power the circuit breaker 112 on or off. In other embodiments, a software reset may be initiated on the circuit breaker 112 by another computing device (e.g., computing devices 102, 104, 106), thereby causing the circuit breaker 112 to initiate power cycling through the processor 202 remotely. In yet other embodiments, power cycling can occur in response to input from a user. For example, the circuit breaker 112 may cycle power in response to depression of a button on the circuit breaker 112. In some embodiments, the reset may be in response to receiving an indication of a test button being depressed on circuit breaker 112. In some embodiments, in response to a test initiated by the test button being depressed failing, the updated firmware data can be prevented from being written to the volatile memory 230 by the processor 202.

Once the circuit breaker is reset, the slot location in the non-volatile memory 228 where the new updated firmware (e.g., second firmware) is located may be indicated by a flag. This location may be referred to as a second location of non-volatile memory 228, the slot location where the previous firmware version is stored may be indicated by another flag. This location may be referred to as a first location of non-volatile memory 228. When the reset occurs, the processor 202 can monitor where the firmware has been stored and indicate its location in the non-volatile memory 228 with the flag. In some embodiments, if there is a failure in the transfer of the firmware or the firmware fails validation, the processor 202 may instead obtain the original firmware (e.g., first firmware) from its respective location using the location flag. In this regard, the validation pass serves as the gate for the execution of the firmware, that is, when the validation for the firmware fails, the second firmware (e.g., previous version) is stored onto the volatile memory from the non-volatile memory and validated as well. Only if validation passes will the firmware be executed at the volatile memory by the controller.

As used herein, the term “non-volatile memory” refers to any of a plurality of electronic data storage devices that do not require a continuous power supply to retain the data stored therein. As used herein, the term “volatile memory” refers to any of a plurality of non-transitory computer readable media that retains data stored therein while a continuous power supply is provided.

According to various embodiments, the circuit breaker 112 may operate in a networked environment using logical connections to remote network devices through network 110, such as a wireless network, the Internet, or another type of network. The circuit breaker 112 may connect to network 110 through a network interface component 206 connected to the system bus 216. It should be appreciated that the network interface component 206 may also be utilized to connect to other types of networks and remote computing systems. The circuit breaker 112 also includes an input/output component 208 for receiving and processing input from a number of other devices, including a touch user interface display screen or another type of input device. Similarly, the input/output component 208 may provide output to a touch user interface display screen or other output devices.

The circuit breaker 112 may include the power supply 214. In some embodiments, the power supply 214 converts an AC voltage to a regulated DC voltage for use by some or all electrical components connected to the circuit breaker 112.

The circuit breaker 112 may include a measurement circuit 218. In some embodiments, the processor 202 can be configured to execute power metering instructions to aid in performing one or more techniques described herein, such as causing the circuit breaker 112 to collect operating metrics (e.g., current measurements, voltage measurements, power measurements, or the like) and send the collected operating metrics to a remote entity, such as the enterprise (e.g., directly or via wireless communication module 224, or the like).

The circuit breaker 112 may include trip circuitry 220. In some embodiments, the trip circuitry 220 may include one or more components to provide electrical fault protection and to enable the circuit interrupter to switch open in the event of an electrical fault detected by the processor 202.

The circuit breaker 112 may include the actuator 222. In some embodiments, the actuator 222 may be positioned to trip (i.e., unlatch) the operating mechanism of the circuit breaker 112 in response to receiving an electrical trip signal from trip circuitry 220. When the operating mechanism is tripped by the actuator 222, the operating mechanism separates each electrical contact to stop the flow of electrical current through the circuit breaker 112, thereby providing electrical isolation between an upstream electrical power source and downstream electrical load devices.

The wireless communication module 224 uses the network 110 to communicate with the computing device 102, 104, and 106 to download the firmware, while the processor 202 runs safety functions. While the processor 202 is in a normal operation condition and monitoring for electrical faults on the electrical power line, the processor 202 may also be configured to request and/or obtain data (i.e., the firmware) from the wireless communication module 224. In this regard, the circuit breaker 112 is capable of obtaining new firmware from computing devices 102, 104, 106 while in the normal operating mode and the circuit breaker 112 does not require switching to an alternate operating mode (e.g., safe mode) to obtain firmware from computing devices 102, 104, 106 and to store the data in the memory 204.

In circuit breaker 112, a foreground state is where critical operations and tasks are run. A critical task can include a circuit protection task that is safety related. In some embodiments, a critical task can include any tasks that are related to electrical distribution and protection. For example, a ground fault circuit breaker may run a ground protection fault algorithm as a critical task. A background state is where tasks that are typically considered a lower priority than foreground tasks are performed. Background tasks may include obtaining data from computing devices 102, 104, 106 by wireless communication module 224, writing the obtained data to non-volatile memory 228, and setting a flag pointing to the appropriate memory location, in various embodiments. For example, obtaining firmware transferred from an external computing device and writing it in memory is typically at a lower priority and considered a background task.

In some embodiments, the wireless communication module 224 can obtain the new firmware update from computing device 102, 104, and 106 while the circuit breaker 112 is performing safety functionalities (e.g., monitoring for fault conditions) utilizing the firmware written onto the volatile memory 230. The new updated firmware is obtained and stored in a partitioned slot location in non-volatile memory 228 and does not interfere with the current execution of the firmware in volatile memory 230. Per industry standards, background tasks cannot impede the performance of foreground tasks. As such, conventional circuit are not capable of obtaining firmware updates from an external computing device and writing the updated firmware in memory while simultaneously providing safety functionalities because doing so can interrupt the foreground tasks performed by the circuit breaker.

In some embodiments, if the circuit breaker 112 is connected to the network 110, it may be possible to transmit the firmware update to all connected circuit breakers 112. This can be advantageous in instances in which, for example, a software issue is detected on the firmware to circuit breakers 112 of a particular type or running a particular version of firmware, so that a new firmware update can be output to all circuit breakers 112 of the particular type from a central location, using the wireless communication module 224. For example, point-to-point contact between a technician and a customer can occur using a smart panel installed on the bottom of the circuit breaker 112, where the enterprise may push and receive data to and from the circuit breaker 112.

The circuit breaker 112 may include the sensor 226. In some embodiments, the circuit breaker 112 may include one or more of the sensor 226 for monitoring one or more parameters of the circuit breaker 112, the power line, the connected electrical load devices, other parameters of the electrical circuit, or any combinations thereof. In some embodiments, the sensor 226 may be coupled to the circuit breaker 112. In some embodiments, information from the sensor 226 (e.g., IoT devices, current sensors, voltage sensors, temperature sensors, weather monitors, security systems, location information, etc.) can be included in the data obtained from the circuit breaker 112 to provide alerts, updated firmware, updated fault tripping settings.

The circuit breaker 112 may include an input/output component 208. In some embodiments, the input/output component 208 may include therein the routines that help transfer information between elements within circuit breaker 112, such as during startup, is stored in the ROM 512. The circuit breaker 112 further includes a mass storage device 502. The mass storage device 502 can store software instructions and data.

The mass storage device 502 is connected to the processor 202 through a mass storage controller (not shown) connected to the system bus 216. The mass storage device 502 and its associated computer-readable data storage media provide non-volatile, non-transitory storage for the circuit breaker 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

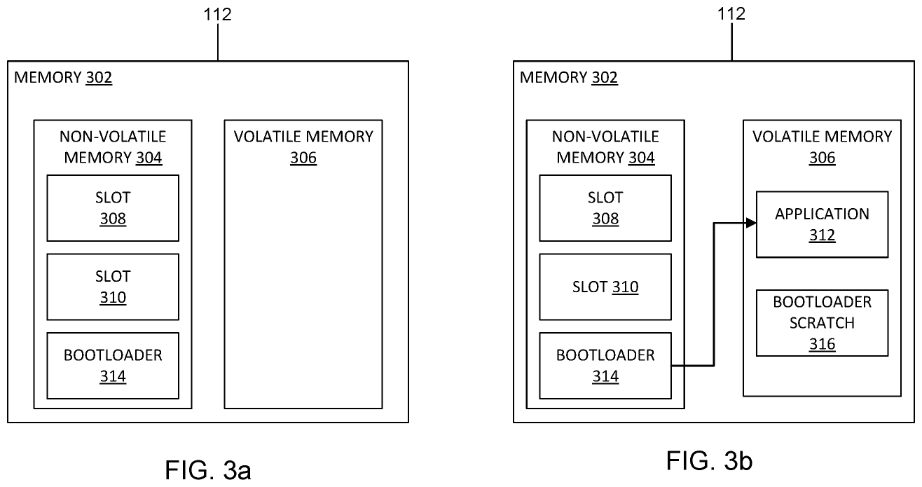

FIG. 3a shows a block diagram illustrating a portion of circuit breaker 112 of FIG. 1, according to some embodiments. FIG. 3b shows a block diagram illustrating the portion of circuit breaker 112 of FIG. 1, according to some embodiments. FIGS. 3a and 3b will be described collectively, unless specified otherwise.

The circuit breaker 112 may include memory 302. The memory 302 may correspond to non-volatile memory 228 in FIG. 2, according to some embodiments. The memory 302 may include a non-volatile memory 304 and a volatile memory 306. In some embodiments, the non-volatile memory 304 may be a computer readable flash memory media and the volatile memory 306 may be a computer readable RAM media.

The non-volatile memory 304 may include a plurality of slots partitioning the non-volatile memory 304. The plurality of slots may include at least slot 308 and slot 310. In some embodiments, the non-volatile memory 304 may include slot 308, slot 310, and one or more other additional slots. Each slot may be a size configured to enable the firmware to be stored in the respective slot. Slot 308 may be a primary slot and the slot 310 may be a secondary slot, in some embodiments.

The circuit breaker 112 may include therein firmware stored in an available slot in the non-volatile memory 304 such as, for example, slot 308 or slot 310. One or more versions of firmware may be stored onto respective slots at non-volatile memory 304. In some embodiments, the non-volatile memory 304 may include a most recent firmware stored in one of the slots such as, for example, slot 308 or slot 310, and the non-volatile memory 304 may include a previous version firmware stored in one of the other slots such as, for example, the other of slot 308 and slot 310 that does not have stored thereon the most recent firmware.

When circuit breaker 112 obtains a new firmware, e.g., from an external computing device, the new firmware may be stored in an available slot of non-volatile memory 304. If all designated slots for storing firmware are occupied, the slot having stored thereon the oldest firmware may be overwritten with the new firmware. In this regard, the most recent firmware may be identified as the most recent firmware obtained from an external computing device. In other embodiments, the most recent firmware may be identified by the firmware itself, e.g., through an identifier, timestamp, key, other like properties, or any combinations thereof.

The firmware may be read from the respective slot in the non-volatile memory 304 and written (i.e., copied) onto volatile memory 306 for controlling and performing the operations of circuit breaker 112, according to some embodiments. For example, the most recent firmware may be the original firmware stored onto slot 308 of non-volatile memory 304 at manufacture. In addition, when the circuit breaker 112 obtains a firmware update from an external computing device, such as computing devices 102, 104, 106 of FIG. 1, the firmware may be stored onto an available slot in non-volatile memory 304. For example, if slot 308 is occupied by the previous version firmware that is a copy of the firmware being executed at volatile memory 306, the updated firmware may be stored onto slot 310 or another next available slot at non-volatile memory 304. It is to be appreciated by those having ordinary skill in the art that although FIGS. 3a and 3b show non-volatile memory 304 as having a certain number of slots, this is not intended to be limiting and the non-volatile memory 304 may include one or more additional slots for storing data. In some embodiments, non-volatile memory 304 may include slot 308 and slot 310. In other embodiments, non-volatile memory 304 may include slot 308, slot 310, and one or more additional slots. In yet other embodiments, non-volatile memory 304 may include slot 308, slot 310, and bootloader 314.

Referring to FIG. 3b, upon powering on circuit breaker 112 and the processor (e.g., processor 202 in FIG. 2), or when circuit breaker 112 is reset, the controller performs an initialization in which the controller identifies the most recent firmware in the slots of non-volatile memory 304. The most recent firmware is copied and stored onto volatile memory 306 as application 312. The controller then executes the firmware stored in volatile memory 306 as application 312. During the controller's execution of the firmware stored on volatile memory 306 (e.g., during normal operation of circuit breaker 112), the circuit breaker 112 may receive a new firmware from an external computing device, e.g., computing devices 102, computing device 104, or computing device 106, and buffer and/or write the firmware to the next available slot in non-volatile memory 304. The controller may be capable of receiving, buffering, and storing the firmware update onto non-volatile memory 304 while the circuit breaker 112 is performing its normal safety functionalities on the power line of the electric circuit, that is, the execution of the firmware (e.g., application 312) stored on volatile memory 306 is uninterrupted by the storing of the new updated firmware onto non-volatile memory 304. Upon completion, the most recently obtained firmware can be executed (e.g., copied and written in volatile memory 306 as application 312) by performing a hardware or software reset of the controller and processor 202 and/or by cycling power off and on.

In some embodiments, the non-volatile memory 304 may include bootloader 314 and the volatile memory 306 may include bootloader scratch 316 to enable the processor to validate the firmware prior to executing the firmware as application 312 from volatile memory 306. The bootloader 314 and bootloader scratch 316 may be partitions in their respective non-volatile memory 304 and volatile memory 306, according to some embodiments. During the initialization of the circuit breaker 112, the processor may validate the most recent firmware prior to booting the circuit breaker 112 using the most recent firmware. If the test fails, the previous firmware (relative to the most recent firmware that failed validation) and stored in one of the other slots of non-volatile memory 304 may instead be copied and stored to the volatile memory 306 for execution rather than the new firmware. The processor may also validate the previous firmware prior to execution of the previous firmware in volatile memory 306 to verify the integrity and/or authenticity of the previous firmware prior to execution as application 312. In this regard, after the copying and storing of firmware from non-volatile memory 304 to volatile memory 306, the processor may perform a validation of the firmware to ensure the firmware is authentic and that the data is not compromised or corrupted.

The volatile memory 306 may include the bootloader scratch 316. The bootloader scratch 316 may have stored thereon metadata related to the initialization of the circuit breaker 112 and may include data corresponding to the copying and storing of the firmware from non-volatile memory 304 to volatile memory 306. In addition, during the swapping of firmware from the most recent firmware to the previous firmware at volatile memory 306 by the processor due to the most recent firmware failing validation, data (e.g., metadata) may be stored onto the bootloader scratch 316. In some embodiments, the bootloader scratch 316 may have stored thereon any of a plurality of data including, but is not limited to, swap status, slot data, sector data, encryption/decryption data, keys, other like data, or any combinations thereof. In some embodiments, the bootloader scratch 316 may have stored thereon data that may be utilized by the processor to validate the integrity and/or authenticity of the firmware being uploaded in volatile memory 306.

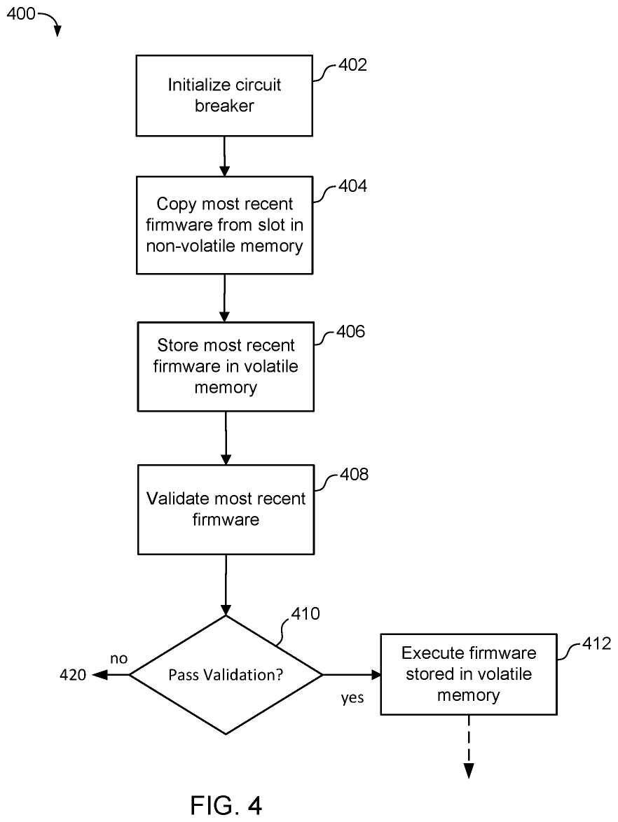

FIG. 4 is a flow diagram illustrating a method 400, according to some embodiments.

At 402, the method 400 includes initializing the circuit breaker. Initializing the circuit breaker may also initialize the controller for circuit breaker and its one or more components. The controller may include one or more components therein such as shown for circuit breaker 112 in FIG. 2. The controller may include, at least, a processor, a non-volatile memory, and a volatile memory. The controller may be configured to execute firmware stored onto the volatile memory, the firmware including instructions to enable the controller to control operations of the circuit breaker including providing safety functionalities on an electrical circuit in electrical connection with the circuit breaker.

At 404, the method 400 includes copying a most recent firmware from its corresponding slot in the non-volatile memory. The non-volatile memory may also be referred to herein as a first memory. In some embodiments, the non-volatile memory may correspond to non-volatile memory 304 from FIG. 3a. In some embodiments, the non-volatile memory may be a flash memory media. The most recent firmware may be stored onto the non-volatile memory at manufacturing of the circuit breaker device, according to some embodiments. In other embodiments, the most recent firmware may be a most recent firmware version that was obtained by the processor from an external computing device and stored onto an available slot location of the non-volatile memory. The non-volatile memory may include therein a plurality of slot locations, in some embodiments. In other embodiments, the non-volatile memory may include at least two slot locations. In some embodiments, the non-volatile memory may include a first slot and a second slot partitioning the non-volatile memory. The non-volatile memory may further include a third slot partition, in some embodiments. In other embodiments, the non-volatile memory may include two slots, three slots, or more slots.

The most recent firmware may be stored in one of the slots of the non-volatile memory. The non-volatile memory may also have stored thereon a previous firmware in one of the other slots. In this regard, in some embodiments, where the non-volatile memory includes two different versions of firmware stored in their respective slot locations, the processor may be configured to identify the most recently obtained firmware version based on a flag or key associated with the respective slot location. In other embodiments, the processor may identify the most recent firmware based on properties of the firmware.

At 406, the method 400 includes storing the most recent firmware in the volatile memory. In some embodiments, the volatile memory may correspond to volatile memory 306 from FIG. 3b, and the most recent firmware may be stored onto volatile memory 306 as application 312. The volatile memory may be a RAM media, according to some embodiments.

At 408, the method 400 includes validating the most recent firmware. Validating the most recent firmware includes the processor verifying an authenticity and an integrity of the firmware stored in the volatile memory prior to execution. The firmware is validated to protect against altered or corrupted firmware data that may render the circuit breaker controller susceptible to attacks from third parties, hinder proper operation of the circuit breaker, and/or may lead to damaging the one or more electrical components of the electrical circuit.

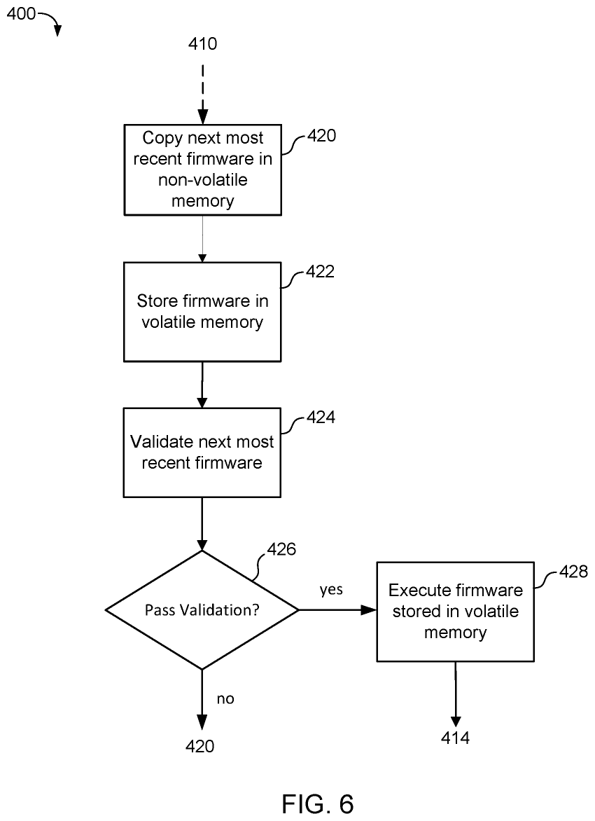

At 410, the method 400 includes determining if the most recent firmware passes validation. If the firmware passes validation, the operations continue to block 410 to enable initialization of the circuit breaker to continue as normal. If the firmware fails validation, the operations continue to block 420 as shown in FIG. 6 and will be further described herein.

At 412, the method 400 includes executing the most recent firmware stored in the volatile memory. The processor executes the firmware instructions stored onto the volatile memory to enable the processor to control operations of the circuit breaker including providing safety functionalities on the electrical circuit, that is, the processor executes the most recent firmware to enable the processor to monitor digital signal characteristics on an electrical power line in electrical connection with the circuit breaker and to identify patterns indicative of an electrical fault on the power line.

During initialization, the processor copies, and stores firmware from the non-volatile memory to the volatile memory, and then executes the firmware stored onto the volatile memory so that circuit breaker operations, including the corresponding safety functionalities, are not interrupted when the circuit breaker receives firmware updates from an external computing device. The processor may thereby obtain and store the firmware update to an available slot in the non-volatile memory without interrupting circuit breaker operations or having to switch an operating mode of the circuit breaker from a normal mode to a safe mode where active monitoring of connected electrical devices may be interrupted to enable storing the firmware update onto the memory of the circuit breaker.

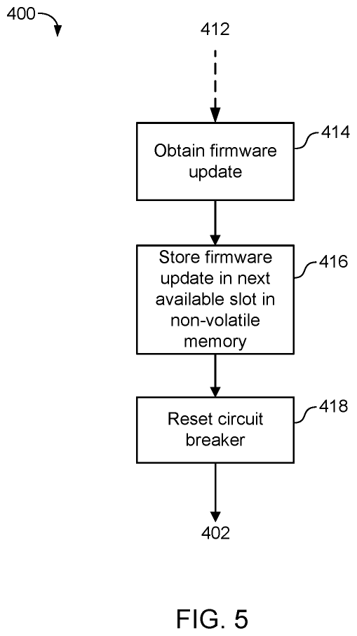

FIG. 5 is a flow diagram of a portion of the method 400, according to some embodiments.

At 414, the method 400 includes obtaining a firmware update by the circuit breaker. The firmware update may be obtained by the controller from an external computing device. In some embodiments, the firmware update may be obtained from another external computing device distinct from the computing device from which the processor obtained the most recent firmware. For example, the most recent firmware may be obtained from a first computing device associated with a manufacturer of the circuit breaker during manufacturing and the firmware update may be obtained from a second computing device associated with a user of the circuit breaker after installation of the circuit breaker in the electrical circuit.

At 416, the method 400 includes storing the firmware update onto a next available slot in the non-volatile memory. The processor may be configured to store the firmware update onto an available slot of the non-volatile memory. For example, the non-volatile memory may include a first slot and a second slot, the most recent firmware may be stored at the second slot, and the firmware update may then be stored onto the first slot. In some embodiments, the most recent firmware may be stored onto one of a first slot location or a second slot location of the non-volatile memory, and the firmware update may be stored onto the other of the first slot location or the second slot location (e.g., the slot not occupied by the most recent firmware). In some embodiments, the other of the first slot location and the second slot location that does not have stored thereon the most recent firmware may have an older version of firmware compared to the most recent firmware, and the processor may be configured to store the firmware update onto the slot location such that the older version of firmware is overwritten by the firmware update.

At 418, the method 400 may include resetting the circuit breaker. Resetting the circuit breaker may cause the power to cycle off and on and may also cause the controller and/or the processor to reset, thereby triggering the circuit breaker to initialize. The processor may then be configured to perform the operations at block 402 of FIG. 4. In some embodiments, the volatile memory may be configured to retain the data stored thereon while power is supplied to the volatile memory, that is, when the circuit breaker is reset and/or power is interrupted, the data stored onto the volatile memory may be erased. As such, when the circuit breaker initializes (or reinitializes), the processor may be configured to perform the operations at block 402 of FIG. 4. In other embodiments, the processor causing the circuit breaker to trip open in response to detecting a fault pattern during the execution of the firmware stored onto the volatile memory may erase the firmware stored onto the volatile memory, and switching the circuit breaker closed again may similarly cause a reset of the circuit breaker such that the controller copies and stores the most recent firmware from the non-volatile memory to volatile memory. If the circuit breaker obtained and stored a firmware update onto the non-volatile memory prior to the circuit breaker being tripped open, the firmware update would be identified by the controller as the most recent firmware and resetting the circuit breaker may then cause the controller to copy and store that firmware from the non-volatile memory and onto the volatile memory for execution.

The reset of the circuit breaker may be performed remotely, in some embodiments. In other embodiments, the reset may be performed from a dedicated local button on the circuit breaker, such as located on a housing of the circuit breaker.

At circuit breaker, in response to being reset, the controller may initialize (or reinitialize) without interrupting power between the one or more electrical devices and the electrical power source, according to some embodiments. That is, monitoring by the controller may be unavailable while the initialization (or reinitialization) is being performed but power may continue to be provided from the electrical power source to the connected electrical load devices through circuit breaker at the power line. In some embodiments, the circuit breaker may be reset without interrupting power at the electrical circuit as long as a time period of the monitoring outage is less than a maximum allowable outage, which may be based on a time period determined by the manufacturer, a user, or by applicable industry regulations. In some embodiments, the reset may be performed without interrupting power at the electrical circuit so long as within a specific time duration. If the time duration is exceeded, however, the controller may be configured to trip open and disconnect the power between the power source and the electrical load devices. In this regard, the controller may be capable of obtaining a firmware update, storing the firmware update onto non-volatile memory, and may then initialize the controller without interrupting power on the electrical circuit between the power source and the electrical load devices. Initializing the controller may include copying the most recent firmware (e.g., firmware update) stored onto non-volatile memory and writing that firmware onto volatile memory to enable the processor to execute that most recent firmware stored onto volatile memory for controlling operations of the circuit breaker. In addition, initializing the controller may further include copying and storing the next most recent firmware should the most recent firmware fail validation, in some embodiments.

FIG. 6 is a flow diagram of another portion of the method 400, according to some embodiments.

If the firmware validation fails during initialization, then, at 420, the method 400 includes copying a next most recent firmware in the non-volatile memory. For example, the firmware that failed validation may be stored at the first slot and the next most recent firmware may be stored at the second slot of the non-volatile memory. In some embodiments, the next most recent firmware may be identified by the controller based on the slot location. For example, based on timestamp data or a key indicating that the firmware in that particular location was the next most recent firmware executed at the circuit breaker. In other embodiments, the next most recent firmware may be identified by properties of the firmware. For example, the firmware may include data corresponding to a firmware version and the controller may identify which firmware to copy and store from the non-volatile memory onto the volatile memory based on the firmware version information.

At 422, the method 400 includes storing the copied firmware from the non-volatile memory in the volatile memory. This operation is similar to block 406 as shown at FIG. 4.

At 424, the method 400 includes validating the next most recent firmware. Validating the next most recent firmware is similar to block 408 at FIG. 2 and includes the processor verifying an authenticity and an integrity of the next most recent firmware stored in the volatile memory for execution. The next most recent firmware is validated again to protect against altered or corrupted firmware data that may render the circuit breaker controller susceptible to attacks from third parties, hinder proper operation of the circuit breaker, and/or may lead to damaging the one or more electrical components of the electrical circuit. For example, the next most recent firmware may have been altered by a malicious software program after being obtained and stored onto the non-volatile memory.

At 426, the method 400 includes determining if the next most recent firmware passes validation. If the firmware passes validation, the operations continue to block 428 to enable initialization of the circuit breaker to continue as normal with the next most recent firmware instead of the firmware that failed validation. If the next most recent firmware also fails validation, the circuit breaker may generate an error that is provided to the user such as by an indicator light on the circuit breaker housing. In some embodiments, the controller may execute the firmware stored in the volatile memory to operate the circuit breaker and to perform the safety operations at the electrical circuit, until the circuit breaker obtains a firmware update such as shown in block 414.

At 428, the method 400 includes executing the firmware stored onto the volatile memory. The processor executes the firmware instructions stored onto the volatile memory to enable the processor to control operations of the circuit breaker including providing safety functionalities on the electrical circuit, that is, the processor executes the next most recent firmware to enable the processor to continue operations including monitoring digital signal characteristics on an electrical power line in electrical connection with the circuit breaker and to identify patterns indicative of an electrical fault on the power line. The controller thereby executes the firmware stored on the volatile memory until the circuit breaker is initialized, or reinitialized, such as shown at block 402 of FIG. 4.

In some embodiments, the controller may send data corresponding to the most recent firmware failing validation and the next most recent firmware instead being executed by the controller to the computing device associated with the user. In other embodiments, this data may be displayed by the circuit breaker. For example, the circuit breaker may include one or more indicator lights to display a status of the circuit breaker including a normal condition, an error condition, the circuit breaker executing an older version firmware due to the most recent firmware failing validation, other indications, or any combinations thereof. In another example, the circuit breaker may include a display (not shown) that can display data including a condition of the circuit breaker, one or more parameters of the power line, the firmware version being executed, an error condition, a normal condition, other parameters, or any combinations thereof.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

As used herein “embedded” means that a first material is distributed throughout a second material.

### Aspects

Various Aspects are described below. It is to be understood that any one or more of the features recited in the following Aspect(s) can be combined with any one or more other Aspect(s).

Aspect 1. A system comprising: a circuit breaker comprising: a processor, and a first memory including a plurality of slots comprising: a first slot, and a second slot; and a second memory; wherein, in response to an initialization of the processor, the processor stores a copy of a most recent firmware obtained by the circuit breaker from one of the first slot and the second slot of the first memory in the second memory.

Aspect 2. The system according to aspect 1, wherein, in response to a first initialization, the processor stores a copy of a first firmware from the first slot or the second slot of the first memory in the second memory and executes the first firmware in the second memory.

Aspect 3. The system according to any of the preceding aspects, wherein, in response to obtaining a second firmware, the processor stores the second firmware in the other of the first slot and the second slot not storing the first firmware; wherein, in response to a second initialization of the processor after obtaining the second firmware, the processor stores a copy of the second firmware from the other of the first slot and the second slot in the first memory in the second memory to enable execution of the second firmware; wherein the first firmware is a previous firmware stored in the first memory, and the second firmware is the most recent firmware stored in the first memory.

Aspect 4. The system according to aspect 3, wherein the processor stores the second firmware in an available slot of the first slot and the second slot of the first memory such that execution of the first firmware is uninterrupted.

Aspect 5. The system according to any of the preceding aspects, wherein the circuit breaker further comprises: a wireless communication module, wherein the wireless communication module is configured to be placed in electronically communicable connection with an external computing device to send and receive data including firmware.

Aspect 6. The system according to any of the preceding aspects, wherein the first memory comprises a non-volatile computer readable media; wherein the second memory comprises a volatile computer readable media.

Aspect 7. The system according to any of the preceding aspects, wherein the first memory comprises a flash memory; wherein the second memory comprises a RAM.

Aspect 8. The system according to any of the preceding aspects, wherein the processor is further configured to perform a validation of the most recent firmware before executing the most recent firmware stored in the second memory.

Aspect 9. The system according to aspect 8, wherein, in response to failing the validation of the most recent firmware, storing a copy of a previous firmware relative the most recent firmware in the second memory, and performing the validation of the previous firmware before executing the previous firmware.

Aspect 10. A circuit breaker device comprising: a processor; a non-volatile computer readable media comprising: at least two slots, wherein a first firmware is stored in a first slot or a second slot; a volatile computer readable media; wherein the processor is configured to perform operations comprising: in response to a first initialization, the processor stores a copy of the first firmware from the first slot or the second slot of the non-volatile computer readable media in the volatile computer readable media and executes the first firmware from the volatile computer readable media, in response to obtaining a second firmware, the processor stores the second firmware in the other of the first slot and the second slot not storing the first firmware, and in response to a second initialization of the processor after obtaining the second firmware, the processor stores a copy of the second firmware from the other of the first slot and the second slot of the non-volatile computer readable media in the volatile computer readable media to enable execution of the second firmware; and wherein the first firmware is a previous firmware stored in the non-volatile computer readable media, and the second firmware is a most recent firmware stored in the non-volatile computer readable media; wherein the processor stores the second firmware in an available slot of the first slot and the second slot of the non-volatile computer readable media such that execution of the first firmware is uninterrupted.

Aspect 11. The device according to aspect 10, further comprising: a wireless communication module, wherein the wireless communication module is configured to be placed in electronically communicable connection with an external computing device to send and receive data including at least one of the first firmware and second firmware.

Aspect 12. The device according to aspects 10 or 11, wherein the non-volatile computer readable media comprises a flash memory.

Aspect 13. The device according to aspects 10, 11, or 12, wherein the volatile computer readable media comprises a RAM.

Aspect 14. The device according to aspects 10, 11, 12, 13, or 14, wherein the processor is further configured to perform operations comprising: performing a validation of the most recent firmware before executing the most recent firmware stored in the volatile computer readable media.

Aspect 15. The device according to aspect 14, wherein the processor is further configured to perform operations comprising: in response to failing the validation of the most recent firmware, storing a copy of a previous firmware relative the most recent firmware in the volatile computer readable media, and performing the validation of the previous firmware before executing the previous firmware.

Aspect 16. A method comprising: copying, by a processor in response to an initialization, a most recent firmware from a slot of a plurality of slots at a first memory; storing, by the processor, the most recent firmware in a second memory; and executing, by the processor, the most recent firmware stored in the second memory to enable the processor to provide safety functionalities for a circuit breaker based on the most recent firmware; wherein the most recent firmware is a first firmware.

Aspect 17. The method according to aspect 16, wherein the method further comprises: obtaining, by the processor, a second firmware; and storing, by the processor, the second firmware in an available second slot of the plurality of slots at the first memory; wherein the processor storing the second firmware in the first memory does not interrupt execution of the first firmware.

Aspect 18. The method according to aspect 17, wherein the first firmware is a previous firmware, and the second firmware is the most recent firmware; wherein the initialization of the processor causes the processor to copy and store the most recent firmware from the first memory in the second memory for execution.

Aspect 19. The method according to aspects 16, 17, or 19, wherein the method further comprises: performing a validation of the most recent firmware stored in the second memory; and executing, by the processor in response to passing the validation, the most recent firmware in the second memory.

Aspect 20. The method according to aspects 16, 17, 18, or 19, wherein the first memory further includes a previous firmware stored at an available second slot of the plurality of slots, and the method further comprises: copying, by the processor, the previous firmware in the first memory; storing, by the processor, the previous firmware in the second memory; performing a validation of the previous firmware; and executing, by the processor in response to passing the validation, the previous firmware stored in the second memory to enable the processor to perform the safety functionalities based on the previous firmware.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A system comprising:
a circuit breaker comprising:
a processor, and
a first memory including a plurality of slots comprising:
a first slot, and
a second slot; and
a second memory;
wherein, in response to an initialization of the processor, the processor stores a copy of a most recent firmware obtained by the circuit breaker from one of the first slot and the second slot of the first memory in the second memory.

2. The system of claim 1, wherein, in response to a first initialization, the processor stores a copy of a first firmware in the first slot or the second slot of the first memory in the second memory and executes the first firmware in the second memory.

3. The system of claim 2, wherein, in response to obtaining a second firmware, the processor stores the second firmware in the other of the first slot and the second slot not storing the first firmware;
wherein, in response to a second initialization of the processor after obtaining the second firmware, the processor stores a copy of the second firmware from the other of the first slot and the second slot in the first memory in the second memory to enable execution of the second firmware;
wherein the first firmware is a previous firmware stored in the first memory, and the second firmware is the most recent firmware stored in the first memory.

4. The system of claim 3, wherein the processor stores the second firmware in an available slot of the first slot and the second slot of the first memory such that execution of the first firmware is uninterrupted.

5. The system of claim 1, wherein the circuit breaker further comprises:
a wireless communication module,
wherein the wireless communication module is configured to be placed in electronically communicable connection with an external computing device to send and receive data including firmware.

6. The system of claim 1, wherein the first memory comprises a non-volatile computer readable media;
wherein the second memory comprises a volatile computer readable media.

7. The system of claim 6, wherein the first memory comprises a flash memory;
wherein the second memory comprises a RAM.

8. The system of claim 1, wherein the processor is further configured to perform a validation of the most recent firmware before executing the most recent firmware stored in the second memory.

9. The system of claim 8, wherein, in response to failing the validation of the most recent firmware, storing a copy of a previous firmware relative the most recent firmware in the second memory, and performing the validation of the previous firmware before executing the previous firmware.

10. A circuit breaker device comprising:
a processor;
a non-volatile computer readable media comprising:
at least two slots,
wherein a first firmware is stored in a first slot or a second slot;
a volatile computer readable media;
wherein the processor is configured to perform operations comprising:
in response to a first initialization, the processor stores a copy of the first firmware from the first slot or the second slot of the non-volatile computer readable media in the volatile computer readable media and executes the first firmware in the volatile computer readable media,
in response to obtaining a second firmware, the processor stores the second firmware in the other of the first slot and the second slot not storing the first firmware, and
in response to a second initialization of the processor after obtaining the second firmware, the processor stores a copy of the second firmware from the other of the first slot and the second slot of the non-volatile computer readable media in the volatile computer readable media to enable execution of the second firmware; and
wherein the first firmware is a previous firmware stored in the non-volatile computer readable media, and the second firmware is a most recent firmware stored in the non-volatile computer readable media;
wherein the processor stores the second firmware in an available slot of the first slot and the second slot of the non-volatile computer readable media such that execution of the first firmware is uninterrupted.

11. The device of claim 10, further comprising:
a wireless communication module,
wherein the wireless communication module is configured to be placed in electronically communicable connection with an external computing device to send and receive data including at least one of the first firmware and second firmware.

12. The device of claim 10, wherein the non-volatile computer readable media comprises a flash memory.

13. The device of claim 10, wherein the volatile computer readable media comprises a RAM.

14. The device of claim 10, wherein the processor is further configured to perform operations comprising:
performing a validation of the most recent firmware before executing the most recent firmware stored in the volatile computer readable media.

15. The device of claim 14, wherein the processor is further configured to perform operations comprising:
in response to failing the validation of the most recent firmware, storing a copy of a previous firmware relative the most recent firmware in the volatile computer readable media, and
performing the validation of the previous firmware before executing the previous firmware.

16. A method comprising:
copying, by a processor in response to an initialization, a most recent firmware from a slot of a plurality of slots at a first memory;
storing, by the processor, the most recent firmware in a second memory; and
executing, by the processor, the most recent firmware stored in the second memory to enable the processor to provide safety functionalities for a circuit breaker based on the most recent firmware;
wherein the most recent firmware is a first firmware.

17. The method of claim 16, wherein the method further comprises:
obtaining, by the processor, a second firmware; and
storing, by the processor, the second firmware in an available second slot of the plurality of slots at the first memory;
wherein the processor storing the second firmware in the first memory does not interrupt execution of the first firmware.

18. The method of claim 17, wherein the first firmware is a previous firmware, and the second firmware is the most recent firmware;
wherein the initialization of the processor causes the processor to copy and store the most recent firmware from the first memory in the second memory for execution.

19. The method of claim 16, wherein the method further comprises:
performing a validation of the most recent firmware stored in the second memory; and
executing, by the processor in response to passing the validation, the most recent firmware in the second memory.

20. The method of claim 19, wherein the first memory further includes a previous firmware stored at an available second slot of the plurality of slots, and the method further comprises:
copying, by the processor, the previous firmware in the first memory;
storing, by the processor, the previous firmware in the second memory;
performing a validation of the previous firmware; and
executing, by the processor in response to passing the validation, the previous firmware stored in the second memory to enable the processor to perform the safety functionalities based on the previous firmware.
